(19) United States
(12) Patent Application Publication
(10) Pub. No.: US 2016/0071259 A1
(43) Pub. Date: Mar. 10, 2016

(54) Wearable device assembly inspection devices and methods

(71) Applicants: Ross Popescu, San Francisco, CA (US); Richard Zhu, San Francisco, CA (US)

(72) Inventors: Ross Popescu, San Francisco, CA (US); Richard Zhu, San Francisco, CA (US)

(73) Assignee: AliphCom, San Francisco, CA (US)

(21) Appl. No.: 14/121,465

(22) Filed: Sep. 8, 2014

(51) Int. Cl. G06T 7/00; G06T 7/40; G06F 1/16

(52) U.S. Cl. CPC G06T 7/0004; G06F 1/163; G06T 7/408

(57) ABSTRACT

Automated optical inspection of a wearable device and/or sub-assemblies of the wearable device in-situ in an ambient environment where temperature and ambient lighting are need not be controlled are described. A key gold unit for the wearable device or a subassembly of the wearable device may be mounted to an automated optical inspections system that captures images of the key gold unit, converts the image from a color space it was captured in to a Hue, Saturation and Value/Brightness color space. Units under test are imaged while stationary or while being rotated (e.g., 360 degrees) and are imaged. Image data is converted into the Hue, Saturation and Value/Brightness color space and compared with the data from the key gold unit to determine if the unit under test is color matched with the key gold unit. Functionality such as near field communications, capacitive touch, display functionality and others may be tested.

### FIELD

Embodiments of the present application relate generally to hardware, software, wired and wireless communications, RF systems, wireless devices, wearable devices, biometric devices, health devices, fitness devices, and consumer electronic (CE) devices.

### BACKGROUND

Some conventional optical inspection system require environments in which temperature and lighting are controlled in order to produce repeatable results in color matching or image recognition, for example. However, in a production environment it may not be desirable or cost effective to perform conventional optical inspection due to difficulties that may arise in trying to control temperature and lighting conditions, such as color temperature of light and light intensity. Color matching may require expensive optics and digital cameras, that typically operate in a color space that is does not mimic how the human eye perceives color.

Accordingly, there is a need for apparatus, systems and methods for automated optical inspection that do not require controlled environments and uses a color space that mimics human color perception.

### BRIEF DESCRIPTION OF THE DRAWINGS

Various embodiments or examples (“examples”) are disclosed in the following detailed description and the accompanying drawings:

FIG. 1 depicts one example of a flow diagram for device testing in an automated optical inspection system;

FIG. 2 depicts one example of a flow diagram for testing a near field communication system in an automated optical inspection system;

FIG. 3 depicts one example of a flow diagram for testing device functionality in an automated optical inspection system;

FIG. 4 depicts a side view of a wearable device;

FIG. 5 depicts a bottom profile view of a wearable device and a top profile view of icons on a cover of the wearable device;

FIG. 6 depicts examples of different configurations of wearable devices;

FIG. 7 depicts a profile view of an automated optical inspection system;

FIG. 8 depicts a side view of an automated optical inspection system;

FIG. 9 depicts another side view of an automated optical inspection system;

FIG. 10 depicts a profile view an automated optical inspection system; and

FIG. 11 depicts icons on device covers being inspected on automated optical inspection system.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including but not limited to implementation as a device, a wireless device, a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

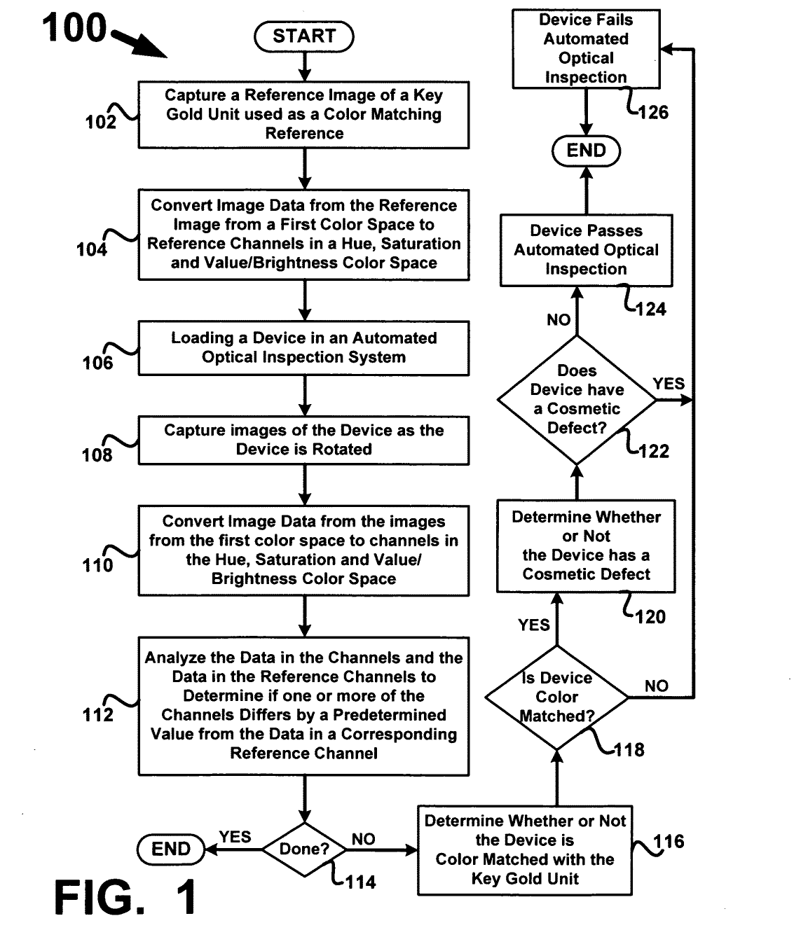

Reference is now made to FIG. 1 where one example of a flow diagram 100 for device testing in an automated optical inspection system is depicted. At a stage 102 a reference image of a key gold unit that may be used as a color matching reference is captured using an image capture device, such as a three megapixel high definition imaging sensor that may incorporate CMOS image sensors, for example. The image may be captured in a first color space, such as a RGB color space in which there is image data in red, green and blue channels. The key gold unit may be a reference unit that has been previously inspected and determined to be without defect in cosmetics, color or other parameters that justify it being used as a reference against which other devices, such as a wearable device, will be compared.

At a stage 104 the first color space of the reference image (e.g., a RGB color space) may be converted to reference channels in a Hue, Saturation and Value/Brightness color space (HSV). The data for the reference channels may be stored in memory (e.g., non-volatile memory) of a computer system, for example.

At a stage 106, a device (e.g., a device under test) may be loaded into an automated optical inspection system. Image capture devices in the automated optical inspection system may be used to capture the reference image of the key gold unit. The key gold unit may be mounted to the automated optical inspection system or loaded on the automated optical inspection system prior to loading the device. The device may be a model of device that is identical to a model of the key gold unit. The device may be one of many devices in an assembly line or other fabrication process.

At a stage 108, images of the device may be captured by one or more image capture devices in the automated optical inspection system. The device may be rotated (e.g., 360 degrees) while the images are being captured.

At a stage 110, image data that was captured from the device may be converted from the first color space (e.g., a RGB color space) to channels in the HSV color space.

At a stage 112, the data in the channels of the HSV color space that were captured from the device and the data in the reference channels for the image captured from the key gold unit may be analyzed to determine if one or more of the channels differs by a predetermined value from the data in a corresponding reference channel. For example, all channel data from the Hue channels captured from the device may be analyzed with the Hue data in the reference channel to determine if Hue channel differs by a predetermined Hue value from the Hue reference channel. Similarly, Saturation and Value/Brightness channel data may be analyzed to determine if they differ from Saturation and Value/Brightness reference channel data. The predetermined value for Hue, Saturation and Value/Brightness may be different values. The predetermined value may be a delta (Δ) value of a standard value for Hue, Saturation and Value/Brightness. For example, Hue may have a standard value for the key gold unit of 0.445 and the image captured from the device may differ by a delta (e.g., +/−) of 1.097, Saturation may have a standard value of 3.505 and delta of 9.9970, and Value/Brightness may have a standard value of 3.177 and a delta of 31.226. An algorithm executing on a compute engine may use statistical analysis to determine differences in distribution of HSV in the channels for the device from center values of HSV for the reference channels. Wide distributions from the center values are not automatically indicative of a poor color match between the device and the key gold unit and may arise due to coatings or due difference in fine geometric textures of the surface coatings, etc.

At a stage 114 a determination may be made as to whether or not the flow 100 is done. If a YES branch is taken, then flow 100 may terminate. On the other hand, if a NO branch is taken, then flow 100 may transition to another stage, such as a stage 116.

At the stage 116, results from analysis at the stage 114 may be used to determine whether or not the device is color matched with the key gold unit. At a stage 118, if the device is not color matched, a NO branch may be taken and the stage 118 may transition to a stage 126 where the device may be determined to have failed automated optical inspection and flow 100 may terminate. If the device is color matched, then a YES branch may be taken and stage 118 may transition to a stage 120 where a determination may be made as to whether or not the device has any cosmetic defects. If a YES branch is taken, then stage 122 may transition to the stage 126. If a NO branch is taken, then stage 122 may transition to a stage 124 where the device may be determined to have passed automated optical inspection and flow 100 may terminate. Image data for the device that was captured may include data indicative of cosmetic defects including but not limited to scratches, dents, blemishes, scuffs, burning, pin holes, flash (e.g. from a molding process), voids, discoloration, heat marks, shine spots, etc., just to name a few.

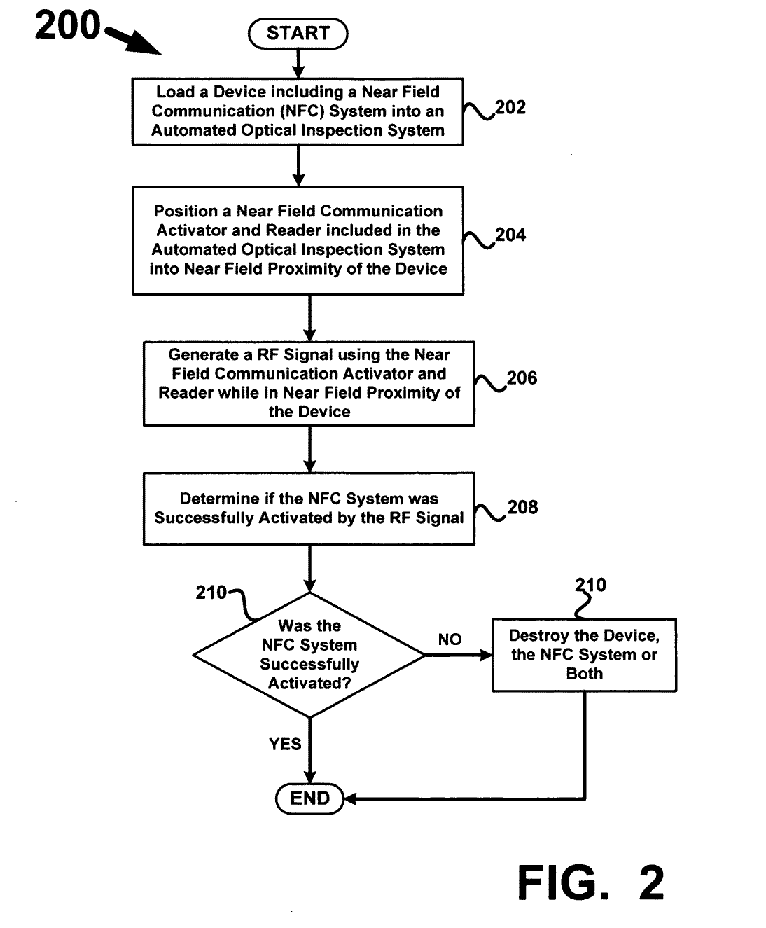

Moving on to FIG. 2 where one example of a flow diagram 200 for testing a near field communication system in an automated optical inspection system is depicted. The automated optical inspection system described above in reference to FIG. 1 may be used to test other functionality of the device and that functionality may be tested on one device while another device is being imaged as described above. Therefore, the automated optical inspection system may be configured to perform different tests on different devices at the same time.

At a stage 202 a device that includes a near field communication (NFC) system may be loaded into the automated optical inspection system. At a stage 204 a near field communication activator and reader, that is included in the automated optical inspection system, may be positioned (e.g., by a robotic system, end effector, actuator, etc.) in near field proximity of the device. Near field proximity may include making a direct contact between the NFC activator and reader and a portion of the device that includes the NFC system, for example. In other examples, near field proximity may include positioning the NFC activator and reader at a distance of about 10 mm or less away from the device or a portion of the device that includes the NFC system.

At a stage 206 a radio frequency (RF) signal is generated by the NFC activator and reader while the NFC activator and reader is positioned in near field proximity of the device. An antenna coupled with a radio or RF system in the NFC activator and reader may generate the RF signal, for example.

At a stage 208, a determination may be made as to whether or not the NFC system was successfully activated by the RF signal generated by the NFC activator and reader. Successful activation may include an NFC antenna of the NFC system generating an electrical signal in response to the RF signal, powering a NFC chip that is coupled with the NFC antenna, and the NFC chip transmitting another RF signal using the NFC antenna. The reader in the NFC activator and reader may be coupled with the radio/RF system of the NFC activator and reader and may read data include in the another RF signal to determine if the data is indicative of successful activation. The data may include financial information used for monetary transactions, such as in a NFC payment system.

At a stage 210 a determination of successful activation may be made. If activation was successful, a YES branch may be taken and flow 200 may terminate. If activation was not successful, a NO branch may be taken and flow 200 may transition to a stage 210. At the stage 210 the device, the NFC system or both may be destroyed. If the NFC system is not permanently attached with the device, the NFC system may be removed or otherwise extracted from the device and subsequently destroyed. If the NFC system cannot be removed from the device or may damage the device if removed, then the device may be destroyed. Destruction may include burning in a furnace, pulverizing, smashing, crushing, or using an impact gun, for example. The destruction may be operative to irretrievably destroy the NFC chip in the NFC system. Destruction may be mandated by contract or other agreement with a financial institution or government body. After destruction is verified, flow 200 may terminate.

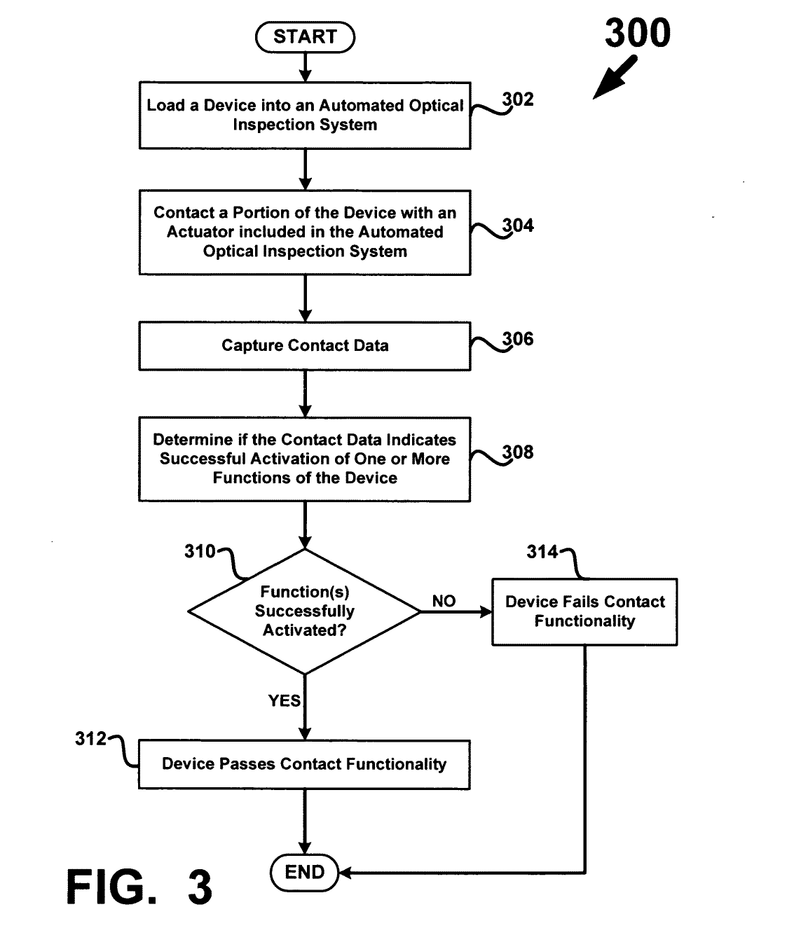

Turning now to FIG. 3 where one example of a flow diagram 300 for testing device functionality in an automated optical inspection system is depicted. At a stage 302 a device is loaded into an automated optical inspection system. At a stage 304 a portion of the device is contacted by an actuator included in the automated optical inspection system. At a stage 306 contact data is captured. Capture may include capturing images of the device, detecting sound (e.g., using a microphone) or vibration (e.g., using an accelerometer) generated by the device, or receiving a signal transmitted by the device (e.g., a RF signal transmitted by the device). Contact by the actuator may activate a display of the device and image capture may be used to determine if the display was activated by the actuator contacting the device. At a stage 308 a determination may be made as to whether or not the contact data indicates successful activation of one or more functions of the device. At a stage 310, if the one or more functions were successfully activated, a YES branch may be taken to a stage 312 where the device may be determined to have passed contact functionality and flow 300 may terminate. On the other hand, if the one or more functions were not successfully activated, then a NO branch may be taken to a stage 314 where the device may be determined to have failed contact functionality and flow 300 may terminate. The actuator may contact a capacitive touch surface or cover of the device. The actuator may include an end effector operative to mimic a human finger, for example. The device may be powered by an electrical power source included in the automated optical inspection system. The device may include an internal power source (e.g., a rechargeable battery, a lithium ion-type battery, etc.) and the device may be powered up by the internal power source during the functionality testing. The contact by the actuator may be operative to activate the device or wake up the device from a standby or low power state. Functionality testing may include testing of power systems of the device.

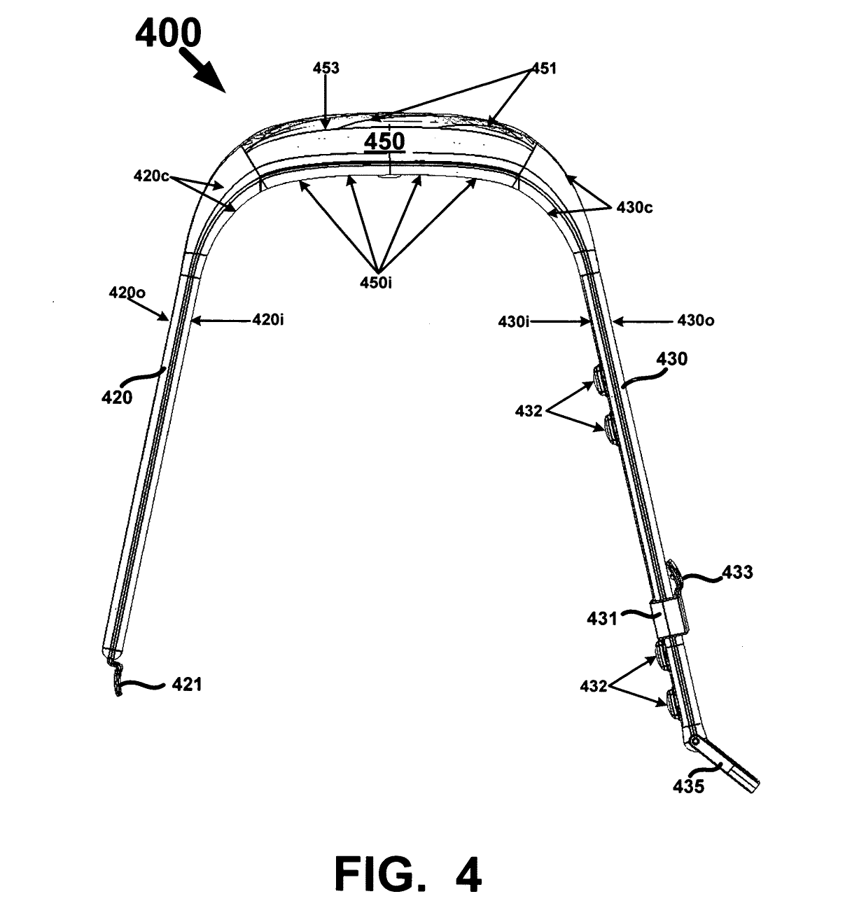

Reference is now made to FIG. 4 where a side view of a wearable device 400 is depicted. Wearable device 400 may be a device that is loaded into the automated optical inspection system. Device 400 may include strap bands 420 and 430 having inner and outer surfaces (420i, 420o) and (430i, 430o) respectively. Strap band 430 may include electrodes 432, a loop 435, and a buckle 431 including a latch 433. Strap band 420 may include a latch 421 configured to couple with latch 433. Loop 435 and latch 421 may be used to secure and hold the device 400 in the automated optical inspection system. Strap bands 420 and 430 may be coupled with a main module 450 that may include circuitry, displays, processors, memory, etc. Main module 450 may include a curved inner surface 450i, ornamental features 451 on a cover 453. Strap bands 430 and 420 may include curved portions 430c and 420c. Image capture devices in the automated optical inspection system may be panned or otherwise translated along one or more axes to capture images of curved and/or irregular surface of device 400 as device 400 is stationary or rotated (e.g., 360 degrees) in the automated optical inspection system.

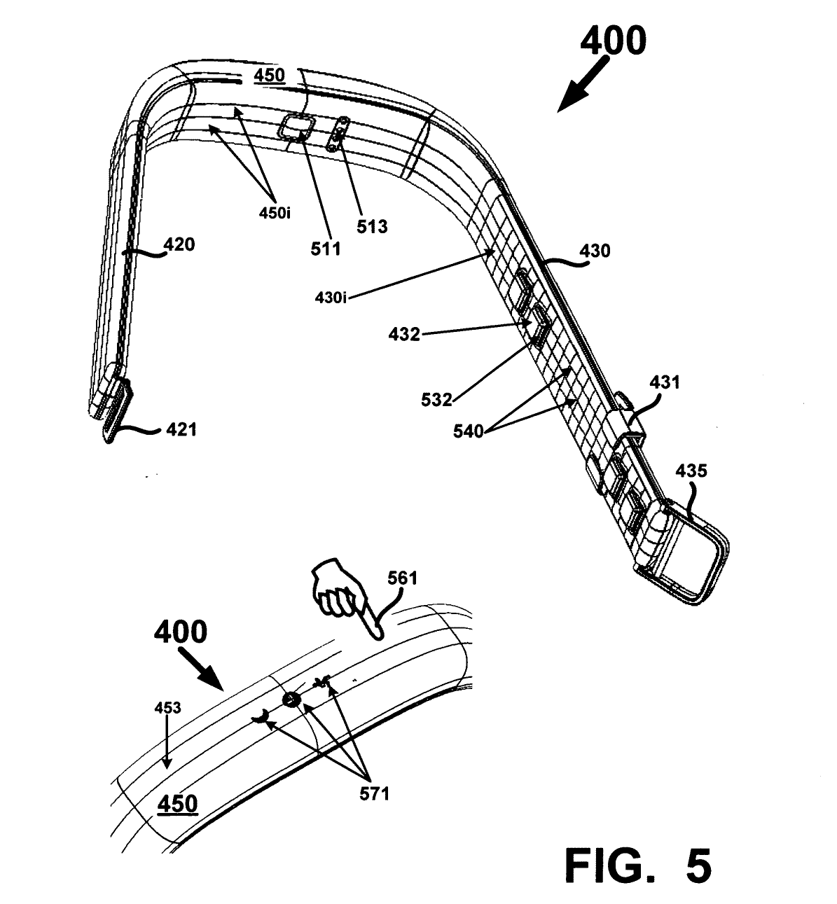

In FIG. 5 a bottom profile view of the wearable device 400 and a top profile view of icons 571 on the cover 453 of the wearable device 400 are depicted. Icons 571 and/or other functions of device 400 may be activated by contact of a human finger 561 or the above mentioned actuator that may be used to simulate touch of the human finger 561. Portions of cover 453 may include perforations (e.g., micro-perforations) that define the icons 571. A light source positioned behind the cover 453 may illuminate the icons 571 in response to contact with cover 453. Cover 453 may be electrically conductive and may be operative as a capacitive touch switch or surface of the main module 450. A sequence of contacts with cover 453 or finger gestures on cover 453 may activate one or more functions of device 400, such as illuminating one or more of the icons 571. Inner surfaces 450i and 430i may include surface features 532 and 540, sensors 511, and data/charging ports 513. Optical inspection by one or more image sensors in the automated optical inspection system may be used to detect cosmetic defects in the icons, micro-perforations, surface features, etc.

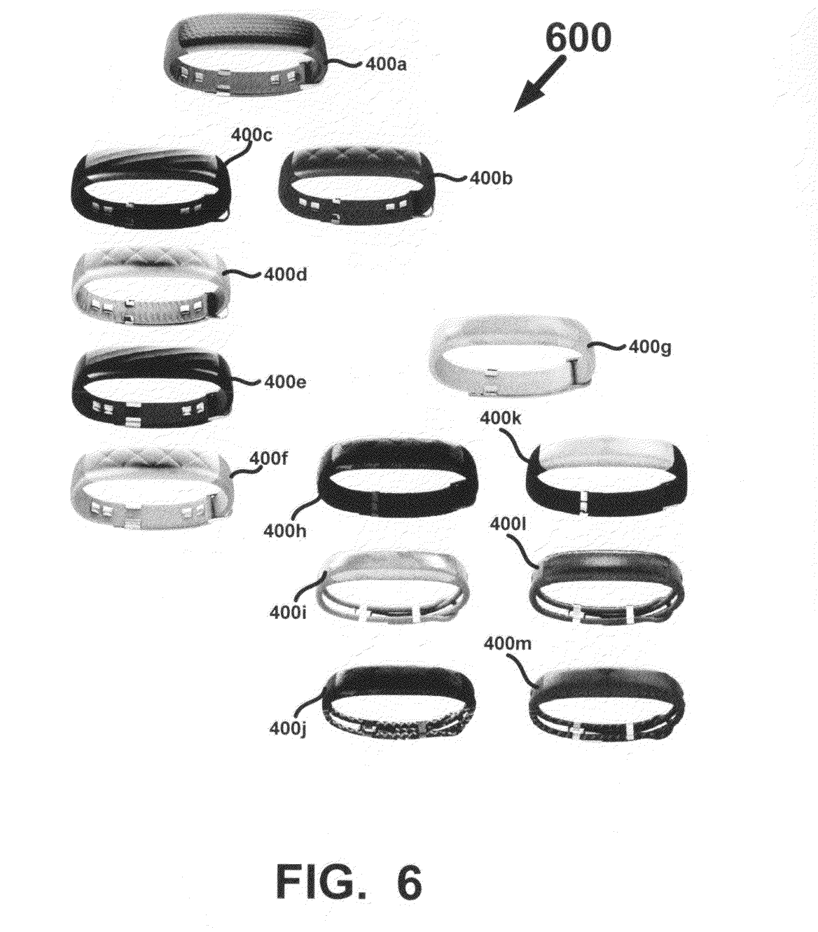

In FIG. 6 examples of different configurations of wearable devices 400a-400m are depicted. The automated optical inspection system may include an exemplary version of each of the different configuration 400a-400m as a key gold unit. Due to differences in surface finishes, metal finishes, materials (e.g., fabric, leather, faux leather, thermoplastic elastomers, ornamental details, braiding, colors, strap band types, etc.) a key gold unit for each configuration 400a-400m may be required for color matching and detection of cosmetic defects, for example.

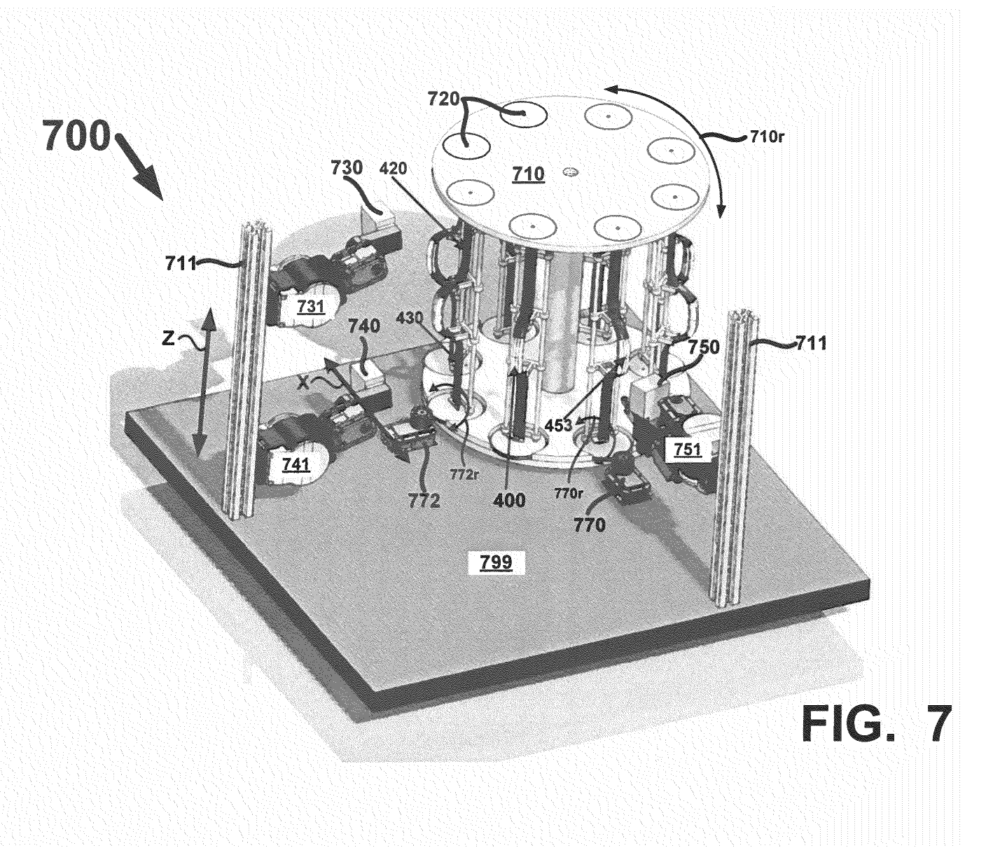

Attention is now directed to FIG. 7 where a profile view of an automated optical inspection system 700 is depicted. System 700 may include posts 711 aligned with a Z-axis and including one or more image capture devices 730, 740, and 750 mounted to 2-axis servo controlled actuators (e.g., motorized articulated arms) 731, 741, and 751 that are coupled with posts 711. Image capture devices 730, 740, and 750 may comprise high-definition (HD) CMOS image sensors. Image sensors 730 and 740 may be tasked to capture images of strap bands 420 and 430 and image sensor 750 may be tasked to capture images of cover 453. A base 799 (e.g., 600 mm on a side) may support pillars 711 and a carousel 710 that includes a plurality of spindles 720 that rotate (e.g., 360 degrees) in the carousel 710 when positioned in front of a spindle drive 770 or 772 (e.g., an edge-friction servo motor). A drive motor coupled with carousel 710 indexes one or more of the spindles 720 in front of image sensors 730, 740, 750 for image capture. Image sensors 730, 740, 750 may capture images of device 400 as it is rotated and the image data may be in a color space, such as an RGB color space. A compute engine (e.g., a server, laptop, PC, tablet, pad or other computing resource) may receive the image data and convert it into a HSY color space. One of the spindles 720 or base 799 may carry the key gold unit for the devices 400 being inspected. The image capture devices (730, 740, 750) may capture an image of the key gold unit (e.g., while stationary) and the image data may be converted to the HSY color space. System 700 may be positioned next to an assembly line where the devices 400 may be procured and mounted in spindles 720 for inspection and testing. Fastening hardware (421, 435) on devices 400 may be coupled with structure in spindle 720 that stretches out the strap bands (420, 430) to allow for accurate placement of the device 400 in the spindle and accurate imaging of the device 400. During image capture, the image capture devices may articulate along two-axes (e.g., X and Z) under control of the 2-axis servo controlled actuators 731, 741, and 751.

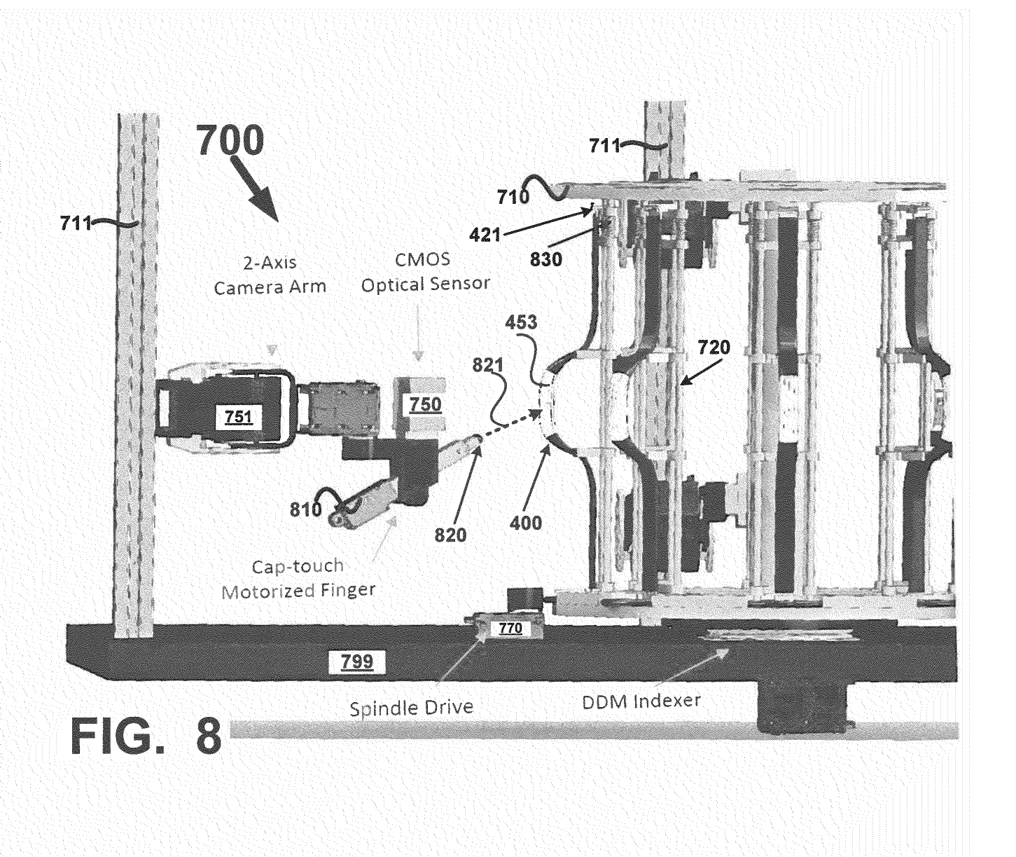

FIG. 8 depicts a side view of the automated optical inspection system 700 and also depicts an actuator 810 with an end effector 820 that may be actuated 821 to contact cover 453 of device 400. Spring system 830 may couple with latch 421 to secure device 400 in spindle 720. Image capture device 750 may capture images of cover 453 after contact has been made by actuator 810. Spindle 720 may include an accelerometer to detect mechanical vibration from device 400 caused by a function activated by contact from actuator 810. System 700 may include a microphone to capture sound generated by device 400 in response to contact by actuator 810.

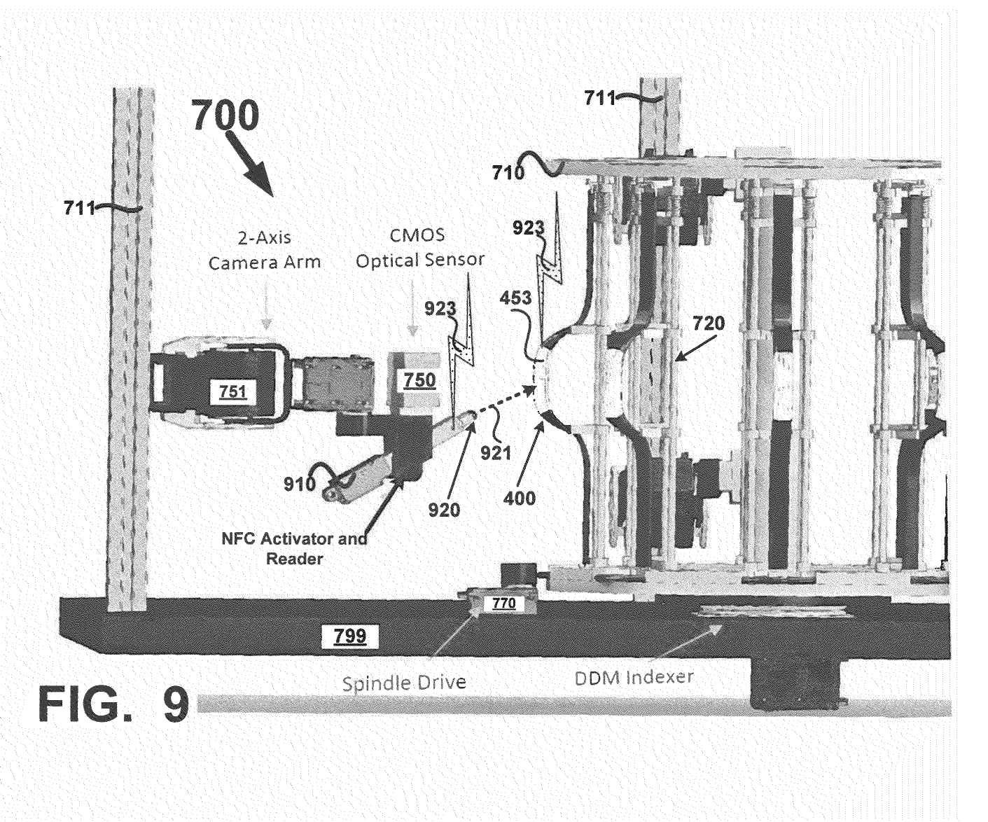

FIG. 9 depicts another side view of an automated optical inspection system 700 in which the 2-axis controller 751 includes a near field activator and reader 910 having a portion 920 that may be positioned in near field proximity 921 of device 400 and generate a RF signal 923. Device 400 may generate another RF signal 925 from a NFC system included in device 400. Successful activation of the NFC system of device 400 may be tested by system 700 as described above in reference to flow 300 of FIG. 3.

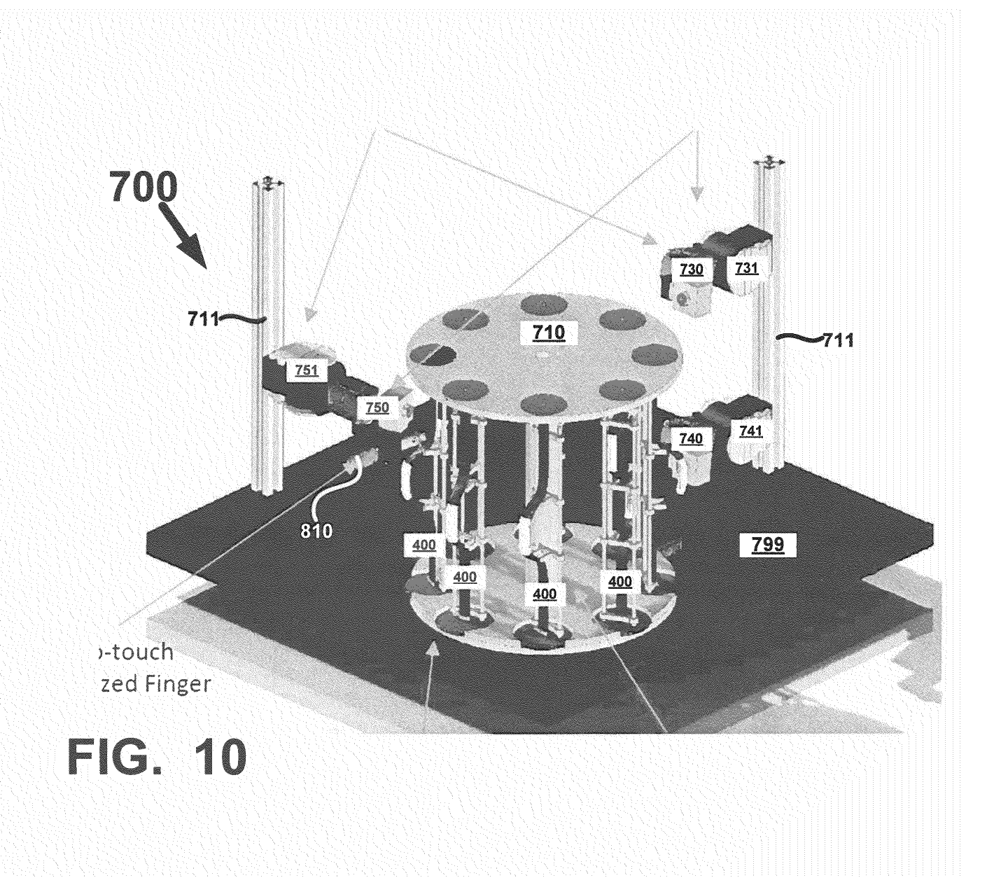

FIG. 10 depicts a profile view the automated optical inspection system 700 from a different perspective. In FIG. 10, one device 400 may be optically inspected by capture device 730 and 740, while another device 400 is tested for functionality of it capacitive touch cover 453 by image capture device 750 and actuator 810.

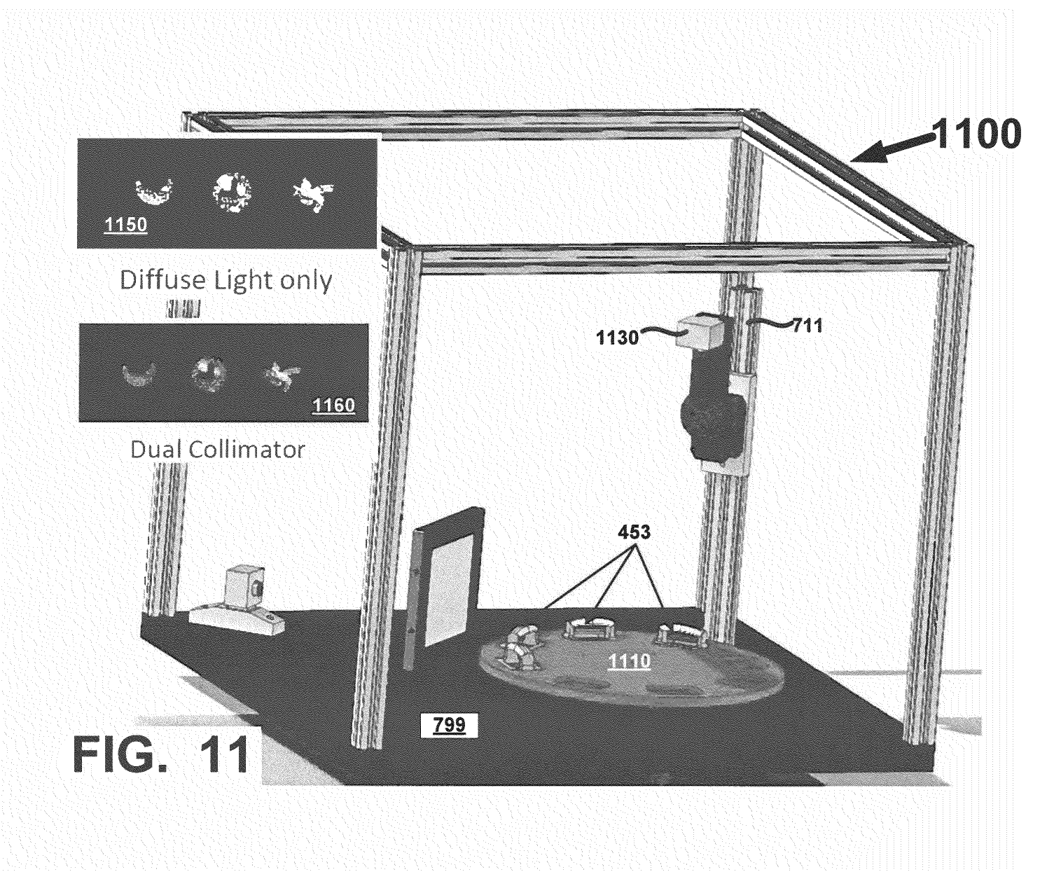

FIG. 11 depicts icons 571 on covers 453 being inspected on automated optical inspection system 1100, which may be system 700 converted over to use for inspection of covers 453. System 1100 may backlight covers 453 from below carousel 1110 using a diffuse light source and/or a dual collimator light source, for example. Image capture device 1130 mounted on pillar 711 may be positioned over covers 453 as they are indexed into position by a motor coupled with carousel 1110. Images captured from icons 571 formed by micro-perforations or other in cover 453 are depicted in 1150 and 1160 under diffuse and dual collimator backlighting conditions. The images in 1150 and 1160 may be used to count the number of perforations for each icon 571 and to determine of the icons 571 are defective (e.g., missing perforations, blocked perforations, too many perforations, cosmetic defects in the perforations, etc.). A key gold unit for a cover 453 may be used for color matching of covers 453 being tested and/or for icon 571 inspection using the key gold unit as a reference for known good icons 571. Other components and/or sub-assemblies of device 400 or other devices may be optically inspected, tested, etc. using system 700 and/or system 1100.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. A method, comprising:
capturing, using a plurality of image capture devices positioned in an automated optical inspection system, a reference image of a key gold unit positioned in the automated optical inspection system, wherein the key gold unit comprises a wearable device operative as a color matching reference;
converting, image data from the reference image, from a first color space the image was captured in, to reference channels in a Hue, Saturation and Value/Brightness color space;
loading at least one wearable device to be inspected into the automated optical inspection system;
capturing, using the plurality of image capture devices, a plurality of images of the at least one wearable device as the device is rotated relative to the plurality of image capture devices;
converting, using a compute engine, data from the plurality of images from the first color space to channels in the Hue, Saturation and Value/Brightness color space; and
analyzing, using the compute engine, the data in the channels and the data in the reference channels to determine if the data in at least one of the channels differs by a predetermined value from the data in a corresponding one of the reference channels.

2. The method of claim 1, wherein the predetermined value is different for each of the reference channels.

3. The method of claim 1, wherein each of the plurality of image capture devices is mounted on a two-axis servo controlled actuator configured to move each image capture device up or down on a first of the two axes, and to pan each image capture device left or right on a second of the two axes that is orthogonal to the first of the two axes.

4. The method of claim 1, wherein the at least one wearable device is mounted to a spindle disposed in a carousel positioned in the automated optical inspection system, the spindle operative to rotate the at least one wearable device 360° while the plurality of images are being captured, the carousel operative to rotate the spindle to an imaging position relative to the plurality of image capture devices and to maintain the imaging position while the plurality of images are being captured.

5. The method of claim 1, wherein two of the plurality of image capture devices are configured to capture images of a first band and a second band of the at least one wearable device.

6. The method of claim 1, wherein one of the plurality of image capture devices is configured to capture images of a cover of the at least one wearable device.

7. The method of claim 1, wherein the automated optical inspection system includes an actuator operative to make contact with a portion of the at least one wearable device, the contact operative to activate one or more functions of the at least one wearable device.

8. The method of claim 7 and further comprising:
capturing contact data; and
determining, using the compute engine, if the contact data indicates the one or more functions were successfully activated by the contact.

9. The method of claim 8, wherein the capturing contact data includes capturing image data, using at least one of the plurality of image capture devices, and comparing, using the compute engine, the image data with reference image data to determine if a light emitting display function of the at least one wearable device was successfully activated by the contact.

10. The method of claim 9 and further comprising: analyzing, using the compute engine, the image data to determine one or more of an intensity of the light emitting display, a perforation hole count of an icon, or a luminance uniformity of the icon.

11. The method of claim 7, wherein the portion comprises a cover of the at least one wearable device, the cover configured to implement a capacitive touch function, the contact operative to activate the capacitive touch function.

12. The method of claim 8, wherein the capturing contact data includes capturing vibration data using a transducer.

13. The method of claim 1, wherein the at least one wearable device includes an internal power source and the at least one wearable device is powered up by the internal power source.

14. The method of claim 1, wherein the analyzing determines whether or not the at least one wearable device is color matched with the key gold unit.

15. The method of claim 1, wherein the analyzing determines whether or not the at least one wearable device has a cosmetic defect.

16. The method of claim 1, wherein during the capturing of the reference image, the capturing of the plurality of images or both, ambient lighting, ambient temperature or both are not controlled in an environment the automated optical inspection system is disposed in.

17. A method, comprising:
loading at least one wearable device to be inspected into an automated optical inspection system, the at least one wearable device including a near field communication system, the automated optical inspection system including a near field communication activator and reader;
positioning the near field communication activator and reader in near field communication proximity of the at least one wearable device;
generating a radio frequency signal from the near field communication activator while the near field communication activator and reader is positioned at the near field communication proximity;
determining, using a compute engine, if the near field communication system was successfully activated by the radio frequency signal; and
destroying the near field communication system, the at least one wearable device or both if the determining indicates the near field communication system was not successfully activated.

18. The method of claim 17, wherein the near field communication proximity comprises positioning the near field communication activator and reader in direct contact with a portion of the at least one wearable device that includes the near field communication system.

19. The method of claim 17, wherein the near field communication system comprises an antenna electrically coupled with a near field communication chip.

20. The method of claim 17 and further comprising:
capturing, using a plurality of image capture devices positioned in the automated optical inspection system, a reference image of a key gold unit positioned in the automated optical inspection system, wherein the key gold unit comprises a wearable device operative as a color matching reference;
converting, using the compute engine, image data from the reference image, from a first color space the image was captured in, to reference channels in a Hue, Saturation and Value/Brightness color space;
capturing, using the plurality of image capture devices, a plurality of images of the at least one wearable device as the device is rotated relative to the plurality of image capture devices;
converting, using the compute engine, data from the plurality of images from the first color space to channels in the Hue, Saturation and Value/Brightness color space; and
analyzing, using the compute engine, the data in the channels with the data in the reference channels to determine if the data in at least one of the channels differs by a predetermined value from the data in a corresponding one of the reference channels.
